(19) United States
(12) Patent Application Publication
(10) Pub. No.: US 2025/0013259 A1
(43) Pub. Date: Jan. 9, 2025

(54) Methods and Devices for Clock Forwarding and Realignment

(71) Applicant: Expedera, Inc., Santa Clara, CA (US)

(72) Inventors: Siyad Chih-Hua Ma, Palo Alto, CA (US); Shang-Tse Chuang, Los Altos, CA (US); Sharad Vasantrao Chole, San Jose, CA (US)

(21) Appl. No.: 18/759,650

(22) Filed: Jun. 28, 2024

Related U.S. Application Data
(60) Provisional application No. 63/525,117, filed on Jul. 5, 2023.

(51) Int. Cl. G06F 1/12; G06F 7/78

(52) U.S. Cl. CPC G06F 1/12; G06F 7/78

(57) ABSTRACT

Disclosed are semiconductor devices that implement relaxed clock forwarding between logic blocks. In one embodiment the system includes a set of logic blocks forming a first processing path. Another set of logic blocks form additional processing paths. A clock is configured to forward the data between the logic blocks asynchronously in the first processing path in which the data is asynchronously forwarded between logic blocks. This forwarding is asynchronous with the additional processing paths data and clock. The ends or last logic block in each path can be synchronized using a synchronizer component. The synchronizer can be a plurality of asynchronous FIFOs. In one embodiment, logic blocks form a matrix and the processing paths are along the rows or columns of the matrix.

### CROSS-REFERENCE TO RELATED APPLICATIONS

This application claims priority to co-pending the Provisional Patent Application of U.S. Patent Application No. 63/525,117 filed Jul. 5, 2023, entitled “Methods and Devices For Resynchronization of Asynchronously Processed Data” which is hereby incorporated by reference herein in its entirety, including all references and appendices cited therein, for all purposes. This application is related to Application No. application Ser. No. 18/315,07, filed May 10, 2023, entitled “POWER-EFFICIENT CLOCKING AND CLOCK SHAPING” which is hereby incorporated by reference herein in its entirety, including all references and appendices cited therein, for all purposes.

### TECHNICAL FIELD

The present application relates to the field of clocking, clocking structures and resynchronizing data in integrated circuits comprised of an array of logic blocks. In particular, but not by way of limitation, the present invention discloses structures and systems for forwarding clocks and realigning the processed data from semiconductor logic blocks to take advantage of power-efficient clocking structures.

### SUMMARY

A digital semiconductor device providing relaxed clocking between sets of logic blocks. In one aspect of the disclosure relates to a first set of logic blocks having a processing structure to process data along a first processing path, from a first logic block in the first processing path to the last logic block element in the first processing path. The device includes additional logic blocks having a processing structure to process data along one or more processing paths, from a first logic block for each of the one or more processing paths to a last logic block in the one or more processing paths.

The device includes a clocking structure where the clock for each logic block in the first processing path follows the data along the first processing path and the clock is asynchronously or mesochronously forwarded to adjacent logic blocks in the first processing path. Further the first processing path being asynchronous or mesochronous clocked with respect to the one or more processing paths.

The device can include a synchronizer connected to the last logic block in the first processing path and to each of the last logic blocks of the one or more processing paths. The synchronizer aligns the data from the first and one or more processing paths to output synchronized data.

In one embodiment, the logic blocks are arranged in an array of rows and columns. The processing paths can be across the rows or down the columns.

In another embodiment, the synchronizer includes a plurality of asynchronous FIFOs. In an alternative embodiment, the synchronizer includes a memory system configured to receive a plurality of data inputs with a plurality of associated asynchronous write clocks and a single read clock. The clock can be forwarded in the same direction as the data flow or in the reverse direction.

In another aspect of the disclosure, a digital semiconductor device is disclosed. The device includes an array of logic blocks having a processing structure to process data having a data flow across multiple hierarchical logic blocks in an array and an end column of logic blocks. Also, the device includes a clocking structure where the clock for each logic block in the array follows the data path through the multiple hierarchical logic blocks and is configured to asynchronously forward the clock through the multiple hierarchical logic blocks. The device includes a synchronizer connected to a plurality of end logic blocks and outputting synchronized data.

In one embodiment, synchronizer includes a plurality of asynchronous FIFOs. In another embodiment, the synchronizer is a memory system configured to receive a plurality of data inputs with a plurality of associated asynchronous write clocks and a single read clock. The forwarded clock can be in the same direction as the data flow. However, the multiple hierarchical logic blocks have a data and clock path in multiple directions.

### BRIEF DESCRIPTION OF THE DRAWINGS

Exemplary embodiments are illustrated by way of example and not limited by the figures of the accompanying drawings, in which like references indicate similar elements.

FIG. 1A is a block diagram of synchronization architecture for asynchronous clocking between logic blocks on a chip.

FIG. 1B is a block diagram of one embodiment of a synchronization component.

FIG. 1C is a block diagram of another embodiment of a synchronization component.

FIG. 2A is a block diagram of synchronization architecture for asynchronous clocking between logic blocks on a chip where the clock and data flows between blocks are in two forward directions.

FIG. 2B is a block diagram of hierarchical blocks with data flows flow and clock direction.

FIG. 3 is a block diagram of synchronization architecture for clock forwarding between logic blocks on a chip where the clock and data flow between blocks are in a forward and write back to memory using memory as storage and synchronizer at the read port.

FIG. 4A is a block diagram of an architecture for the synchronization of pipelined processing with skewed clocks.

FIG. 4B is a block diagram of an architecture for the synchronization of pipelined processing where the clock skew is partially removed along the pipeline.

FIG. 5 is an embodiment of a clock delay chain.

FIG. 6 is a block diagram of clock forwarding in a Multiply-Add Tree.

FIG. 7 is a block diagram of clock forwarding in a group of Multiply-Add Tree outputs.

FIG. 8 is a block diagram of clock forwarding in a Multiply-Add Tree with the clock propagating from block to block.

### DETAILED DESCRIPTION OF EXAMPLE EMBODIMENTS

The following detailed description includes references to the accompanying drawings, which are a part of the detailed description. The drawings show illustrations in accordance with exemplary embodiments. These exemplary embodiments, which are also referred to herein as “examples,” are described in enough detail to enable those skilled in the art to practice the present subject matter. The embodiments can be combined, other embodiments can be utilized, or structural, functional, logical, and electrical changes can be made without departing from the scope of what is claimed. The following detailed description is, therefore, not to be taken in a limiting sense, and the scope is defined by the appended claims and their equivalents.

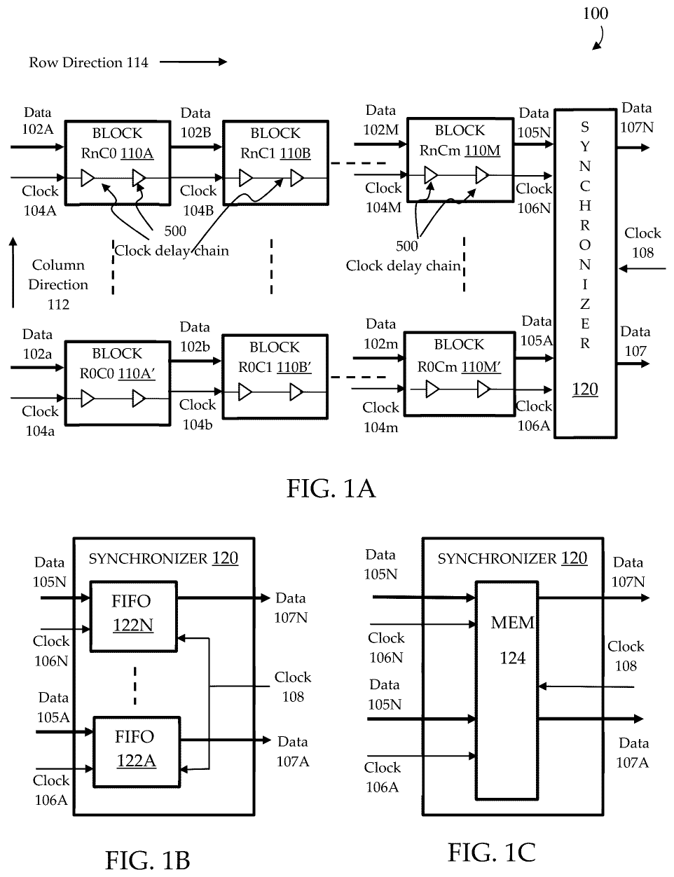

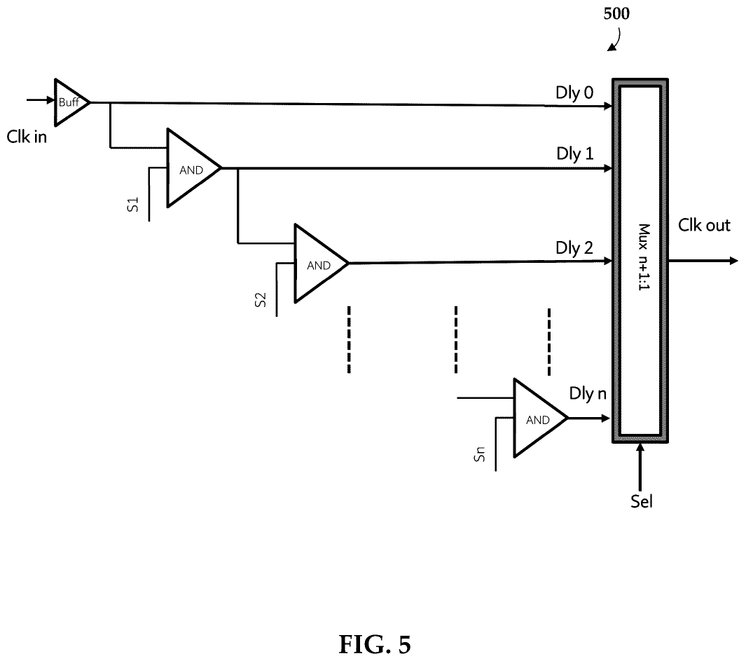

FIG. 1A illustrates one embodiment 100 of rows 114 of logic blocks 110, ROCx-RnCx that has the clock forwarded using the clock delay chain 500 (FIG. 5) inside the logic block rows (R0-Rn) and the output of the last column resynchronize by a synchronization component 120. The reference to rows and columns is not necessarily related to a physical direction but logically a processing path. The term “row” and ‘column” can be interchanged or could be replaced with “a first processing path and “a second processing path” or “a plurality of processing paths” in any dimension. The use of the term of a first set of logic blocks can be a processing path. The use of a first set of logic blocks and a second set of logic blocks structured to form one or more processing paths can be organized into a matrix with rows and columns.

The logic block reference 110x can refer to any of the logic blocks 110A-110M, 110A′-110M′, and any other logic blocks within the matrix of logic blocks. Each logic block 110x can contain the same or different logic components. A logic block can provide a set or configurable logic function. These functions can include, but are not limited to, multiply and add for data in various data formats. The logic block 110x can also be referred to as a block or “BLOCK” as is shown in FIG. 1. The clock 104A-M, 104a-M is used within each logic block 110x and can be synchronous with respect to the internal logic, but the processing between each the logic blocks 110x in a column (C0-Cm) is utilizes clock forwarding in the same direction as data. Each logic block 110x can contain a clock delay buffer 500 for controlling the clock 104x between logic blocks 110x. As discussed in the patent application “Power-efficient Clocking and Clock Shaping” application Ser. No. 18/315,074, filed May 10, 2023, the architecture has the clock follow the data flowing through each logic block 110x. As discussed in the included application referenced above, the key benefits of saving power and semiconductor real estate result from not having to adjust the hold time for the data. Only delay adjustments for the clock are needed.

When the data 102A-102M, 102A′-102M′ has been processed through the row of logic blocks 110A-110Mm 110A′-110M′, the data 105A-105N from logic blocks 110M-110M′ needs to be synchronized for further processing or transmission. This is because the transmission times through each row of logic blocks 110x can vary and thus, the clock 106-106′ are not synchronized.

The synchronizer component 120 buffers the unsynchronized data 105-105′ inputs and provides a synchronized output of data 107A-107N. The data 105-105′ is unsynchronized because the clocks 106-106′ are asynchronous, arriving at different times at the synchronizer 120. The synchronized data 107A-107N is clocked out of the synchronizer 120 for downstream processing. Further information regarding various synchronizer component 120 implementations are provided below.

FIG. 1B is a block diagram of one embodiment of a synchronizer component 120, also referred to as the synchronizer 120. The synchronizer is comprised of a plurality of FIFOs 122A-122N (First In, First Out). Each FIFO 122A-122N receives data 105A-105N from a source where each data source 105A-105N is clocked asynchronously from each other. The FIFOs 122A-122N buffer the data so that when the FIFOs 122A-122N output are clocked 108, the data 107A-107N output is synchronized.

FIG. 1C is a block diagram of another embodiment of a synchronizer 120. The synchronizer component includes a memory component 124 that supports multiple data inputs 105A-105N that are asynchronously and independently clocked into memory 124. The memory 124 also generates a plurality of synchronous outputs 107A-107N. These memory 124 outputs 107A-107N are generated by the clock 108.

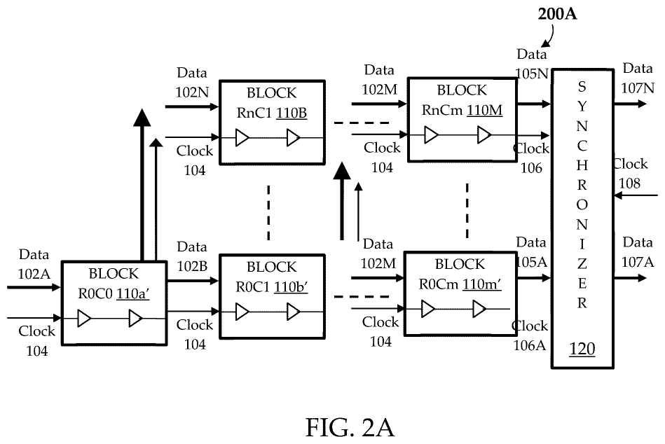

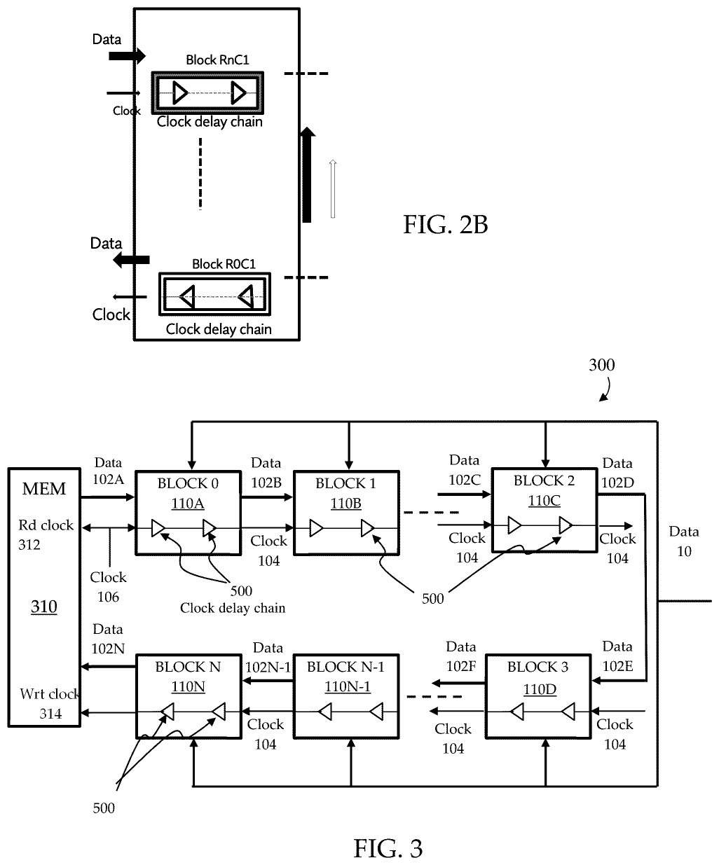

FIG. 2A is a block diagram 200A of another embodiment of a clocking structure with the resynchronization of a plurality of asynchronously clocked array outputs. In the shown embodiment, the data 102B-102N and clock 104 are forwarded both along a row of logic blocks 110a′-110m′ and the row of logic blocks 110B-110M. In the last column of logic blocks 110m′-110M, the data 105A-105N and clocks 106A-106N are generated asynchronously and input into the synchronizer 120. Each logic block 110x can contain a clock delay buffer 500 for controlling the clock 104x between logic blocks 110x.

FIG. 2B is a block diagram of multiple logic blocks where data and clock can flow in both a forward and reverse direction. The implementation of the two directions requires two “Clock Delay Chains” to match the clock being passed to an adjacent logic block. Each clock delay chain needs to delay the clock in the direction of the data is flowing.

FIG. 3 is an example embodiment with clock forwarding and memory write back. While only one logic block 110x of outputs 102A and inputs 102N are show, there can be multiple parallel logic blocks 110x provide input and output to the memory. There can be as many logic blocks 110x in parallel as long as the memory 310 can support the number of inputs and outputs. For example, a memory with 128 bit I/O can have 4 logic blocks chain 100x if the BLOCK has 32 input and output interfacing with memory 310. By forwarding the clock and the associated use of the clock delay chain 500, it can provide for the relaxing of timing along critical paths.

The memory 310 provides synchronization of the data input 102N and data output 102A by having a separate clock for reading the data 312 and writing the data 314. Each logic block 110x can contain a clock delay buffer 500 for controlling the clock 104x between logic blocks 110x.

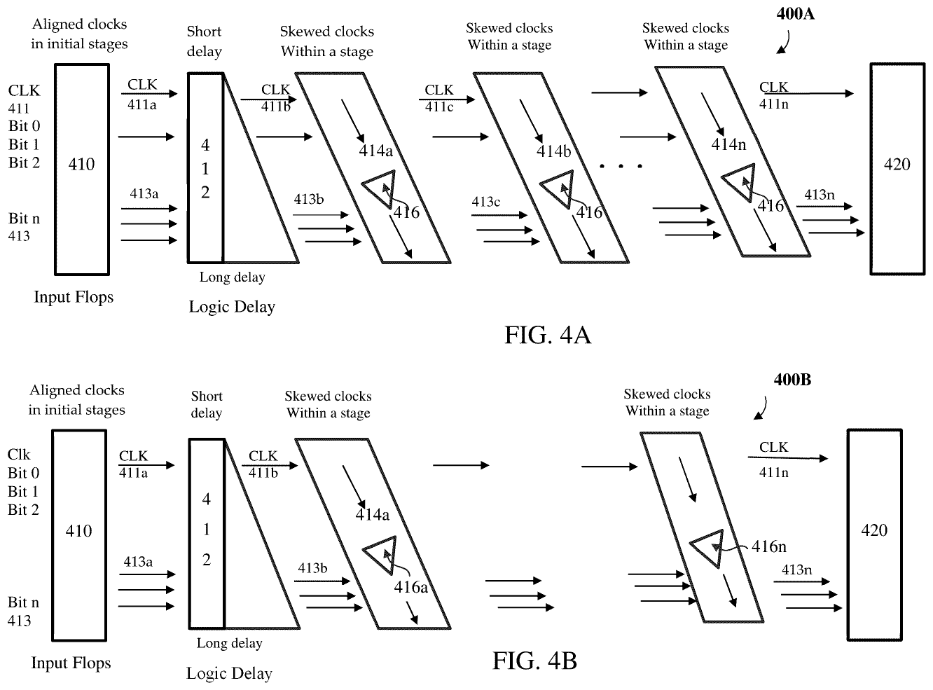

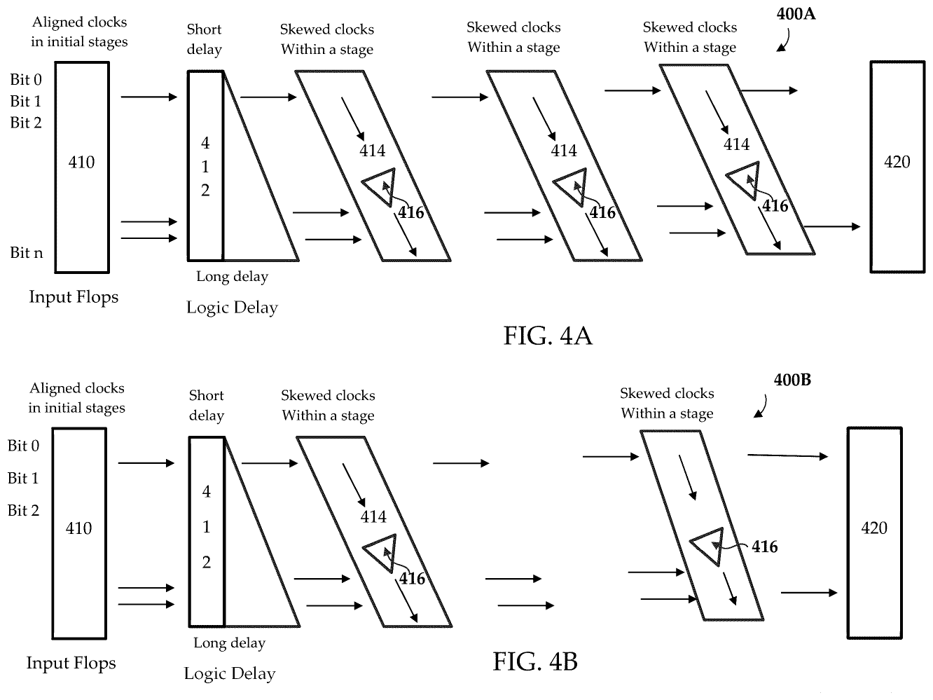

FIG. 4A and FIG. 4B is a block diagram 400A and 400B of the use of clock skew within a pipeline stage to increase the processing rate. An example processing flow subject to pipelining is an add or multiply function. For example, when adding two numbers, the first bit needs to be added to determine if there is a carry bit. Therefore, the adding of the second bit needs to wait until the first bit is added. However, the earlier calculated bits can be supplied to the next stage before the addition of the next bit. Thus, the bits flow between the stages 414a to 414b . . . 414n is staggered with the least significant bit arriving before the next more significant bit. To support the staggard processing the clock needs to be staggard within a stage. Traditionally, short delay paths are padded with delays to equalize the skew among bits within each pipelined stage. However, the first bit can be forwarded to the next pipeline stage before the rest of the bits are processed. The clock needs to be skewed within the pipeline stage for each bit. At the end of the processing, the bits need to be de-skewed to synchronize which is performed by component 420.

In FIG. 4A the input bits 413 are latched by a series of flip flops 410. These bits 413 can be aligned with a clock 411 that stores these bits into the input flip flops 410. These bits 413a are input into component 412 which can delay the bits 413a generating phased bits 413b. As discussed above, the skew is to accommodate the dependency of the second bit on the first bit, the third bit on the second bit and so on. The data 413x, with the skew between the bits, are processed by the stages 414a through 414n. Within each of these stages 414a-414n the input clock 411b-411n is skewed by the component 416 for each bit to accommodate the dependency between bits during processing. The delay provided by the component 416 is based on the delay between the data bits 413x within a stage 414x. For the last stage 414n, the clock 411n and bits 413n are input into the synchronizer component 420. This component 420 synchronizes all the bit inputs 413n inputs and clock input 411n. The synchronized data 413n can be output as a synchronized output (not shown).

The operation of the components in FIG. 4B is similar to FIG. 4A except that within the stages 414a-414n, the delay component 416a-416n remove some are all of the skew between data bits 413x. The removal of the delay between the stages can be evenly spread between the stages 414a-414n or may be concentrated in a subset of the stages. Beneficially, this can enable the de-skewing components to be spread across the pipelined process making better use of power distribution, heat dissipation, and available chip real estate.

FIG. 4B is a block diagram 400B of the use of including clock skew within a pipeline stage to increase the processing rate. Different from the clock skew shown in FIG. 4A, the de-skewing is performed partially or completely in the pipeline. At one or more of the stages, delays are introduced to reduce the skew. The final pipeline output is synchronized by the synchronization component 120.

FIG. 5. is a block diagram 500 of one embodiment of the clock delay chain. The clock delay chain provides an adjustable delay that enables either static configuration of clock delays or dynamic adjustment. Dynamic adjustment can be based on control signals that can be driven by on chip monitoring circuitry. Parameters monitored can include but are not limited to temperature and process.

The clock delay chain circuity includes a multiplexer with a clock input and S1-Sn inputs for selecting the delay, and an output clock. The clock delay chain can have a default setting.

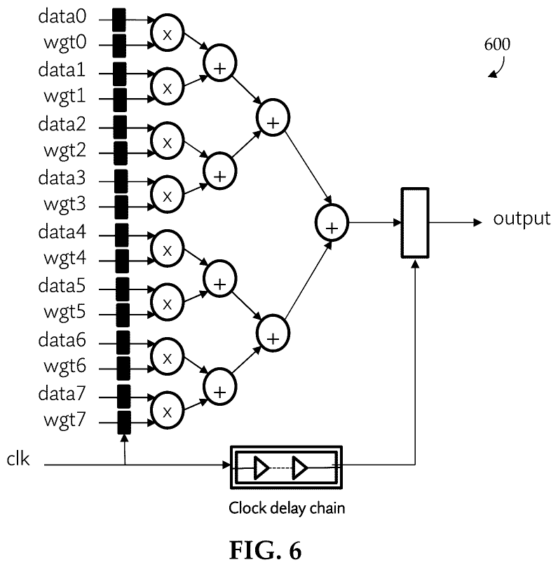

FIG. 6. is a block diagram 600 of one embodiment of using clock forwarding in a Multiply-Add Tree. Multiply-Add Trees are used extensively in matrix operations including but not limited to convolution and dense layers commonly found in Neural Networks.

As the number of inputs increases, more stages are required. Traditional solutions require power hungry gates or additional flip-flops to be inserted within the adder tree. Both solutions result in more chip real estate and power.

The shown embodiment includes a clock delay chain between the input and output flip-flops. This allows more time in the multiply-add tree enabling the meeting of cycle times with less power and requirements for on-chip real estate.

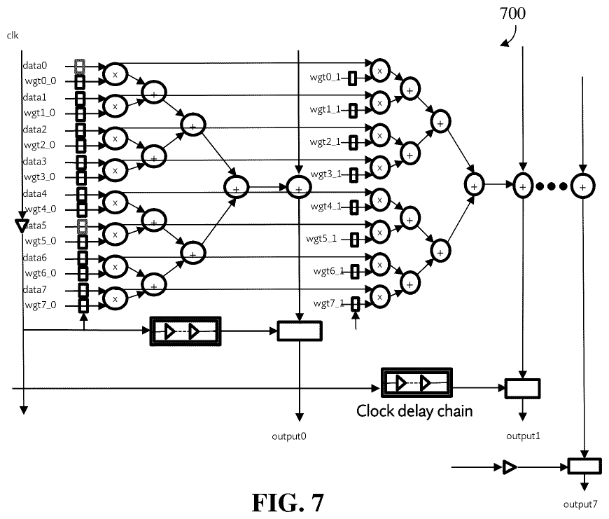

FIG. 7 is a block diagram 700 of an embodiment of the clock forwarding in a group of Multiply-|Add Tree outputs. This architecture arrangement is found where matrix multiplications using the same input but different weights are used. The clock skew from each Tree input to Tree output can be different. Thus the use of the Clock delay chain can be used to synchronize to output generation for further processing.

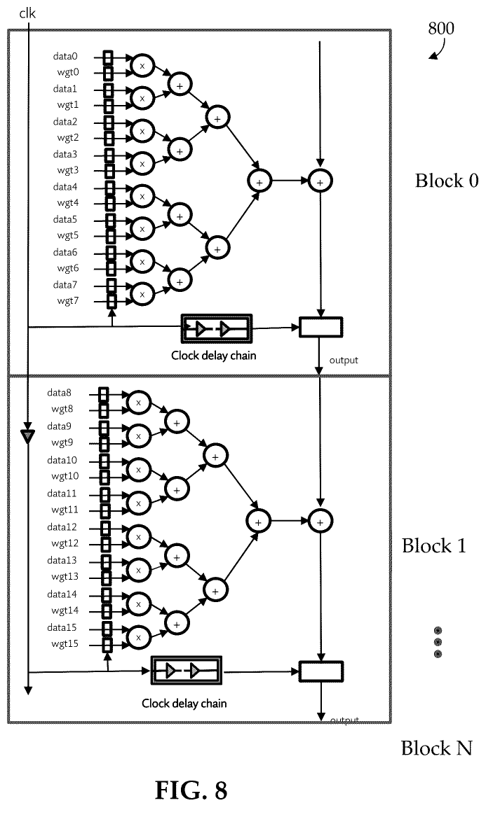

FIG. 8 is a block diagram 800 of an electronic structure for clock forwarding in a Multiply-Add Tree with the clock propagating from logic block to logic block. The Clock delay chain adds a block-to-block clock skew which relaxes the block-to-block timing.

The corresponding structures, materials, acts, and equivalents of all means or step plus function elements in the claims below are intended to include any structure, material, or act for performing the function in combination with other claimed elements as specifically claimed. The description of the present technology has been presented for the purposes of illustration and description but is not intended to be exhaustive or limited to the present technology in the form disclosed. Many modifications and variations will be apparent to those of ordinary skill in the art without departing from the scope and spirit of the present technology. Exemplary embodiments were chosen and described in order to best explain the principles of the present technology and its practical application and to enable others of ordinary skill in the art to understand the present technology for various embodiments with various modifications as are suited to the particular use contemplated.

Aspects of the present technology are described above with reference to flowchart illustrations and/or block diagrams of methods and apparatus (systems) according to embodiments of the present technology.

The flowchart and block diagrams in the Figures illustrate the architecture, functionality, and operation of possible implementations of systems, methods, and computer program products according to various embodiments of the present technology. In this regard, each block in the flowchart or block diagrams may represent a module, section, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or combinations of special purpose hardware.

In the following description, for purposes of explanation and not limitation, specific details are set forth, such as particular embodiments, procedures, techniques, etc., in order to provide a thorough understanding of the present invention. However, it will be apparent to one skilled in the art that the present invention may be practiced in other embodiments that depart from these specific details.

Reference throughout this specification to “one embodiment” or “an embodiment” means that a particular feature, structure, or characteristic described in connection with the embodiment is included in at least one embodiment of the present invention. Thus, the appearances of the phrases “in one embodiment,” “in an embodiment,” or “according to one embodiment” (or other phrases having similar import) at various places throughout this specification are not necessarily all referring to the same embodiment. Furthermore, the particular features, structures, or characteristics may be combined in any suitable manner in one or more embodiments. Furthermore, depending on the context of discussion herein, a singular term may include its plural forms, and a plural term may include its singular form. Similarly, a hyphenated term (e.g., “on-demand”) may occasionally be interchangeably used with its non-hyphenated version (e.g., “on-demand”), a capitalized entry (e.g., “Software”) may be interchangeably used with its non-capitalized version (e.g., “software”), a plural term may be indicated with or without an apostrophe (e.g., PE's or PEs), and an italicized term (e.g., “N+1”) may be interchangeably used with its non-italicized version (e.g., “N+1”). Such occasional interchangeable uses shall not be considered inconsistent with each other.

Also, some embodiments may be described in terms of “means for” performing a task or set of tasks. It will be understood that a “means for” may be expressed herein in terms of a structure, such as a processor, a memory, an I/O device such as a camera, or combinations thereof. Alternatively, the “means for” may include an algorithm that is descriptive of a function or method step, while in yet other embodiments, the “means for” is expressed in terms of a mathematical formula, prose, or as a flow chart or signal diagram.

The terminology used herein is for the purpose of describing particular embodiments only and is not intended to be limiting of the invention. As used herein, the singular forms “a,” “an,” and “the” are intended to include the plural forms as well unless the context clearly indicates otherwise. It will be further understood that the terms “comprises” and/or “comprising,” when used in this specification, specify the presence of stated features, integers, steps, operations, elements, and/or components but do not preclude the presence or addition of one or more other features, integers, steps, operations, elements, components, and/or groups thereof.

It is noted that the terms “coupled,” “connected”, “connecting,” “electrically connected,” etc., are used interchangeably herein to generally refer to the condition of being electrically/electronically connected. Similarly, a first entity is considered to be in “communication” with a second entity (or entities) when the first entity electrically sends and/or receives (whether through wireline or wireless means) information signals (whether containing data information or non-data/control information) to the second entity regardless of the type (analog or digital) of those signals. It is further noted that various figures (including component diagrams) shown and discussed herein are for illustrative purposes only and are not drawn to scale.

If any disclosures are incorporated herein by reference and such incorporated disclosures conflict in part and/or in whole with the present disclosure, then to the extent of conflict, and/or broader disclosure, and/or broader definition of terms, the present disclosure controls. If such incorporated disclosures conflict in part and/or in whole with one another, then to the extent of conflict, the later-dated disclosure controls.

While various embodiments have been described above, it should be understood that they have been presented by way of example only and not limitation. The descriptions are not intended to limit the scope of the invention to the particular forms set forth herein. To the contrary, the present descriptions are intended to cover such alternatives, modifications, and equivalents as may be included within the spirit and scope of the invention as defined by the appended claims and otherwise appreciated by one of ordinary skill in the art. Thus, the breadth and scope of a preferred embodiment should not be limited by any of the above-described exemplary embodiments.

What is claimed is:

1. A digital semiconductor device comprising:
A first set of logic blocks having a processing structure to process data along a first processing path, from a first logic block in the first processing path to the last logic block element in the first processing path;
a second set of logic blocks having a processing structure to process data along one or more processing paths, from a first logic block for each of the one or more processing paths to and last logic block in the one or more processing paths;
a clocking structure where the clock for each logic block in the first processing path follows the data along the first processing path and is configured to asynchronously forward the clock to adjacent logic blocks in the first processing path the first processing path being asynchronous with the one or more processing paths; and
a synchronizer connected to the last logic block in the first processing path and to each of the last logic blocks of the one or more processing paths configured to output synchronized data.

2. The digital semiconductor device of claim 1, wherein the first set of logic blocks and second set are arranged in an array of rows and columns, the first processing path is a row within the array, and the one or more processing paths form additional rows within the array.

3. The digital semiconductor device of claim 1, wherein the synchronizer includes a plurality of asynchronous FIFOs.

4. The digital semiconductor device of claim 1, wherein the synchronizer is a memory system configured to receive a plurality of data inputs with a plurality of associated asynchronous write clocks and a single read clock.

5. The digital semiconductor device of claim 1, wherein the forwarded clock is in the same direction as the data flow.

6. The digital semiconductor device of claim 1, wherein the clocks are forwarded mesochronously.

7. A digital semiconductor device comprising:
an array of logic blocks having a processing structure to process data having a data flow across multiple hierarchical logic blocks in an array and an end column of logic blocks;
a clocking structure where the clock for each logic block in the array follows the data path through the multiple hierarchical logic blocks and is configured to asynchronously forward the clock through the multiple hierarchical logic blocks; and
a synchronizer connected to a plurality of end logic blocks and outputting synchronized data.

8. The digital semiconductor device of claim 7, wherein the synchronizer includes a plurality of asynchronous FIFOs.

9. The digital semiconductor device of claim 7, wherein the synchronizer includes a memory system configured to receive a plurality of data inputs with a plurality of associated asynchronous write clocks and a single read clock.

10. The digital semiconductor device of claim 7, wherein the forwarded clock is in the same direction as the data flow.

11. The digital semiconductor device of claim 7, wherein the multiple hierarchical logic blocks have a data and clock path in multiple directions.

12. The digital semiconductor device of claim 7, wherein the clocks are forwarded mesochronously.

13. A digital semiconductor device comprising:
an initial input stage configured to receive a plurality of data bits;
pipelined processing logic for processing the plurality of data bits, comprising a plurality of stages having a skew between the processing of each data bit within a stage; and
an input clock configured with a delay component between the logic for processing each bit between stages, thereby enabling a bit of the plurality of data bits to be forwarded to a next pipeline stage before the processing of the data bits by the previous pipeline stage.

14. The digital semiconductor device of claim 13, wherein the delay component is based on the time to process each data bit in the pipeline stage.

15. The digital semiconductor device of claim 13 further comprising a synchronizer configured to synchronize the plurality of bits from the last pipeline stage thereby providing a synchronized output.

16. A digital semiconductor device comprising:
an initial input stage configured to receive a plurality of data bits;
pipelined processing logic for processing the plurality of data bits, comprising a plurality of stages having a skew between the processing of each data bit within a stage;
an input clock configured with a delay component between the logic for processing each bit between the stages, thereby enabling a bit of the plurality of data bits to be forwarded to a next pipeline stage before the processing all of the data bits by the previous pipeline stage; and
one or more synchronization delay components configured within one or more stages configured to remove a portion of the skew.

17. A digital semiconductor logic block configured to perform a multiply-add tree comprising:
a plurality of input buffers configured to receive input data and weights and having a clock input;
a plurality of multipliers configured to receive the data and the weights and generated a plurality of multiplier outputs upon the input buffers receiving a clock;
a multi-stage adder tree; and
a clock delay chain configured to provide a clock delay between the enabling the plurality of input buffers and the output buffer by sufficient time for the multiply-add tree to generate the tree output.

18. The digital semiconductor logic block of claim 17, wherein the multi-stage adder tree further comprises:
a plurality of two input adder nodes including,
a plurality leaf inputs connected to the multiplier outputs;
a node output, wherein the adder nodes are configured to sum all the multiplier outputs.

19. The digital semiconductor logic block of claim 17, further comprising:
a second logic block configured to perform a multiply-add tree generating a second tree output; and
a sum block logic configured to sum the tree output and the second tree output, wherein the clock delay chain is configured to provide sufficient delay for the generation of the second tree output.

20. The digital semiconductor logic block of claim 17, wherein the clock delay is based on the number of multipliers and adders.

21. The digital semiconductor logic block of claim 17, wherein the clock delay is configurable.

22. The digital semiconductor logic block of claim 17, wherein the clock delay is based on the data precision and format.

23. The digital semiconductor logic block of claim 17, wherein the clock delay is based on the data precision and format.

24. The digital semiconductor logic block of claim 17, wherein the clocks are forwarded mesochronously.
